(19) United States
(12) Patent Application Publication
(10) Pub. No.: US 2006/0053007 A1
(43) Pub. Date: Mar. 9, 2006

(54) Detection of voice activity in an audio signal

(75) Inventor: Riitta Niemisto, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/214,454

(22) Filed: Aug. 29, 2005

(30) Foreign Application Priority Data
Aug. 30, 2004 (FI) 20045315

(51) Int. Cl. G10L 15/20

(52) U.S. Cl. 704/233

(57) ABSTRACT

A device comprising a voice activity detector for detecting voice activity in a speech signal using digital data formed on the basis of samples of an audio signal. The voice activity detector comprises a first element adapted to examine whether the signal has a highpass nature. The voice activity detector also comprises a second element adapted to examine the frequency spectrum of the signal. The voice activity detector is adapted to provide an indication of speech when the first element has determined that the signal has a highpass nature or the second element has determined that the signal does not have a flat frequency response.

### CROSS-REFERENCE TO RELATED APPLICATIONS

This application claims priority under 35 USC §119 to Finnish Patent Application No. 20045315 filed on Aug. 30, 2004.

### FIELD OF THE INVENTION

The present invention relates to a device comprising a voice activity detector for detecting voice activity in a speech signal using digital data formed on the basis of samples of an audio signal. The invention also relates to a method, a system, a device and a computer program product.

### BACKGROUND OF THE INVENTION

In many digital audio signal processing systems voice activity detection is in use for performing speech enhancement e.g. for noise estimation in noise suppression. The intention in speech enhancement is to use mathematical methods for improving quality of speech that is presented as digital signal. In digital audio signal processing devices speech is usually processed in short frames, typically 10-30 ms, and voice activity detector classifies each frame either as noisy speech frame or noise frame. The international patent application WO 01/37265 discloses a method of noise suppression to suppress noise in a signal in a communications path between a cellular communications network and a mobile terminal. A voice activity detector (VAD) is used to indicate when there is speech or only noise in the audio signal. In the device the operation of a noise suppressor depend on the quality of the voice activity detector.

This noise can be environmental and acoustic background noise from the user's surroundings or noise of electronic nature generated in the communication system itself.

A typical noise suppressor operates in the frequency domain. The time domain signal is first transformed to the frequency domain, which can be carried out efficiently using a Fast Fourier Transform (FFT). Voice activity has to be detected from noisy speech, and when there is no voice activity detected, the spectrum of the noise is estimated. Noise suppression gain coefficients are then calculated on the basis of the current input signal spectrum and the noise estimate. Finally, the signal is transformed back to the time domain using an inverse FFT (IFFT). Voice activity detection can be based on time domain signal, on frequency domain signal or on the both.

In time domain clean speech signal can be denoted by s(t) and noisy speech signal by x(t)=s(t)+n(t), where n(t) is the corrupting additive noise signal. Enhanced speech is denoted by ŝ(t) and the task of the noise suppression is to get it as close to the (unknown) clean speech signal as possible. The closeness is first defined by some mathematical error criterion, e.g. minimum mean squared error, but since there is no single satisfying criterion, the closeness must finally be evaluated subjectively or using a set of mathematical methods that predict the results of listening tests. The notations

$$S ( {ⅇ}^{jω} ) , X ( {ⅇ}^{jω} ) , N ( {ⅇ}^{jω} ) and \hat{S} ( {ⅇ}^{jω} )$$

refer to the discrete time Fourier transforms of the signals in frequency domain. In practice, the signals are processed in zero padded overlapping frames in frequency domain; the frequency domain values are evaluated using FFT. The notations S(ω,n), X(ω,n), N(ω,n) and Ŝ(ω,n) refer to the values of spectra estimated at a discrete set of frequency bins in frame n, i.e. X(ω,n)≈|X(e^{jω})|².

In a prior art noise suppressor the speech enhancement is based on detecting noise and updating the noise estimate according to the following rule
N(ω, n)=λN(ω,n−1)+(1−λ)X(ω,n)
when no speech activity is detected (here N(ω,n) refers to noise estimate while X(ω,n) is the noisy speech and A is a smoothing parameter between 0 and 1. Usually, the value is nearer 1 than 0. The indices ω and n refer to frequency bin and frame, respectively. The underlying assumption is that the frequency content of speech varies more rapidly than that of noise and that VAD detects enough noise in order to update the noise estimate frequently enough. Thus, voice activity detector is in a crucial role in estimation of the noise to be suppressed. When VAD indicates noise, the noise estimate is updated.

Differentiation between noise and speech becomes more difficult when there exist abrupt changes in the noise level. For example, if an engine is started near a mobile phone the level of the noise rapidly increases. The voice activity detector of the device may interpret this noise level increment as beginning of speech. Therefore, the noise is interpreted as speech and the noise estimate is not updated. Also opening a door to a noisy environment may affect that the noise level suddenly rises which a voice activity detector may interpret as a beginning of speech or, in general, a beginning of voice activity.

In the voice activity detector according to the publication WO 01/37265 voice activity detection is carried out by comparing the average power in current frame to the average power of noise estimate by comparing the sum a posteriori SNR

$$\sum \frac{X ( ω , n )}{N ( ω , n - 1 )}$$

to a predefined threshold. In the case of a suddenly rising noise level such detector classifies as speech. Therefore, methods for measuring stationarity are used for recovery. However, voiced phonemes of speech are typically longer than small pauses between phonemes. Thus, the stationarity measures cannot reliably classify as noise unless the pause is longer than any phoneme; typically, it takes seconds to react to a rising noise level.

A straightforward but computationally demanding method of voice activity detection decision is to detect periodicity in a speech frame by computing autocorrelation coefficients in the frame. The autocorrelation of a periodic signal is also periodic with a period in the lag domain that corresponds to the period of the signal. The fundamental frequency of the human speech lies in the range [50, 500] Hz. This corresponds to a periodicity in the autocorrelation lag domain in the range [16, 160] for 8000 Hz sampling frequency and in the range [32, 320] for 16000 Hz sampling frequency. If the autocorrelation coefficients (normalized by the coefficient at 0 delay) of a voiced speech frame are calculated inside those ranges they can be expected to be periodic and a maximum should be found in the lag corresponding to the fundamental frequency of the voiced speech. If the maximum of the normalized autocorrelation coefficients corresponding to possible values of fundamental frequency in speech is above a certain threshold the frame is classified as speech. This kind of voice activity detection can be called as autocorrelation VAD. Autocorrelation VAD can detect voiced speech rather accurately provided that the length of speech frame is sufficiently long compared to the fundamental period of the speech to be detected, but it does not detect unvoiced speech.

In scientific publications there also exist other proposed methods for voice activity detection, for example S. Gazoor and W. Zhang, “A soft voice activity detector based on a Laplacian-Gaussian model”, IEEE Trans. Speech and Audio Processing, vol. 11 no 5, pp. 498-505, September 2003; and M. Marzinzik and B. Kollmeier, “Speech pause detection for noise spectrum estimation by tracking power envelope dynamics”, IEEE Trans. Speech and Audio Processing, vol. 10 no 2, pp. 109-118, February 2002. They are typically rather complicated schemes that compute higher order statistics or speech presence and absence probabilities. In general they are computationally very consuming to implement and the intention is to find all speech in a frame rather than find enough noise for accurate noise estimation. Thus, they are better suited for speech coding applications.

### SUMMARY OF THE INVENTION

The invention tries to improve voice activity detection in the case of suddenly rising noise power, where prior art methods often classify noise frames as speech.

The voice activity detector according to the present invention is called a spectral flatness VAD herein. The spectral flatness VAD of the present invention considers the shape of the noisy speech spectrum. The spectral flatness VAD classifies a frame as noise in the case that the spectrum is flat and it has lowpass nature. The underlying assumption is that voiced phonemes do not have flat spectrum but clear formant frequencies and that unvoiced phonemes have rather flat spectrum but high pass nature. The voice activity detection according to the present invention is based on time domain signal and on frequency domain signal.

The voice activity detector according to the present invention can be used alone but also in connection with autocorrelation VAD or spectral distance VAD or in a combination comprising both of aforementioned VADs. The voice activity detection according to the combination of the three different kind of VADs operates in three phases. First, VAD decision is carried out using autocorrelation VAD that detects periodicity typical to speech, then with spectral distance VAD and finally with spectral flatness VAD if the autocorrelation VAD classifies as noise but the spectral distance VAD classifies as speech. According to a slightly simpler embodiment of the invention the spectral flatness VAD is used in connection with spectral distance VAD without autocorrelation VAD.

The invention is based on the idea that spectrum and the frequency content of an audio signal are examined, when necessary, to determine whether there is speech or only noise in the audio signal. To put it more precisely, the device according to the present invention is primarily characterised in that the voice activity detector of the device comprises:
a first element adapted to examine, whether the signal has a highpass nature, and
a second element adapted to examine the frequency spectrum of the signal,
   wherein the voice activity detector is adapted to provide an indication of speech when one of the following conditions is fulfilled:
the first element has determined that the signal has a highpass nature, or
the second element has determined that the signal does not have a flat frequency response.

The device according to the present invention is primarily characterised in that the voice activity detector comprises:
a first element adapted to examine, whether the signal has a highpass nature, and
a second element adapted to examine the frequency spectrum of the signal,
   wherein the voice activity detector is adapted to provide an indication of speech when one of the following conditions is fulfilled:
the first element has determined that the signal has a highpass nature, or
the second element has determined that the signal does not have a flat frequency response.

The system according to the present invention is primarily characterised in that the voice activity detector of the system comprises:
a first element adapted to examine, whether the signal has a highpass nature, and
a second element adapted to examine the frequency spectrum of the signal,
   wherein the voice activity detector is adapted to provide an indication of speech when one of the following conditions is fulfilled:
the first element has determined that the signal has a highpass nature, or
the second element has determined that the signal does not have a flat frequency response.

The method according to the present invention is primarily characterised in that the method comprises:
examining, whether the signal has a highpass nature, and
examining the frequency spectrum of the signal,
providing an indication of speech when one of the following conditions is fulfilled:
   it is determined that the signal has a highpass nature, or
   it is determined that the signal does not have a flat frequency response.

The computer program product according to the present invention is primarily characterised in that the computer program product comprises machine executable steps for:
examining, whether the signal has a highpass nature, and
examining the frequency spectrum of the signal,
providing an indication of speech when one of the following conditions is fulfilled:
   the signal has a highpass nature, or
   the signal does not have a flat frequency response.

The invention can improve the noise and speech distinction in environments where rapid changes in noise level exist. The voice activity detection according to the present invention may classify audio signals better than existing methods in the case of suddenly rising noise power. In a noise suppressor operating in a mobile terminal, the invention can improve intelligibility and pleasantness of speech due to improved noise attenuation. The invention can also allow the noise spectrum to be updated faster than with the previous solutions that compute stationarity measures, e.g. when an engine starts or a door to a noisy environment is opened. However, the voice activity detector according to the present invention sometimes classifies speech too actively as noise. In mobile communications this only happens when the phone is used in a crowd where there is very strong babble from background present. Such situation is problematic for any method. The difference can be clearly audible in such situations where background noise level suddenly increases. Moreover, the invention allows faster changes in automatic volume control. In some prior art implementations the automatic gain control is limited because of VAD so that it takes at least 4.5 seconds to gradually increase the level by 18 dB.

### DESCRIPTION OF THE DRAWINGS

FIG. 1 illustrates the structure of an electronic device according to an example embodiment of the present invention as a simplified block diagram,

FIG. 2 illustrates the structure of a voice activity detector according to an example embodiment of the present invention,

FIG. 3 illustrates a method according to an example embodiment of the present invention as a flow diagram,

FIG. 4 illustrates an example of a system incorporating the present invention as a block diagram,

FIG. 5.1 illustrates an example of a spectrum of a voiced phoneme,

FIG. 5.2 illustrates examples of a spectrum of car noise,

FIG. 5.3. illustrates examples of a spectrum of an unvoiced consonant,

FIG. 5.4 illustrate the effect of weighting of noise spectrum,

FIG. 5.5 illustrate the effect of weighting of voiced speech spectrum, and

FIGS. 6.1, 6.2 and 6.3. illustrate different example embodiments of voice activity detector as simplified block diagrams.

### DETAILED DESCRIPTION OF THE INVENTION

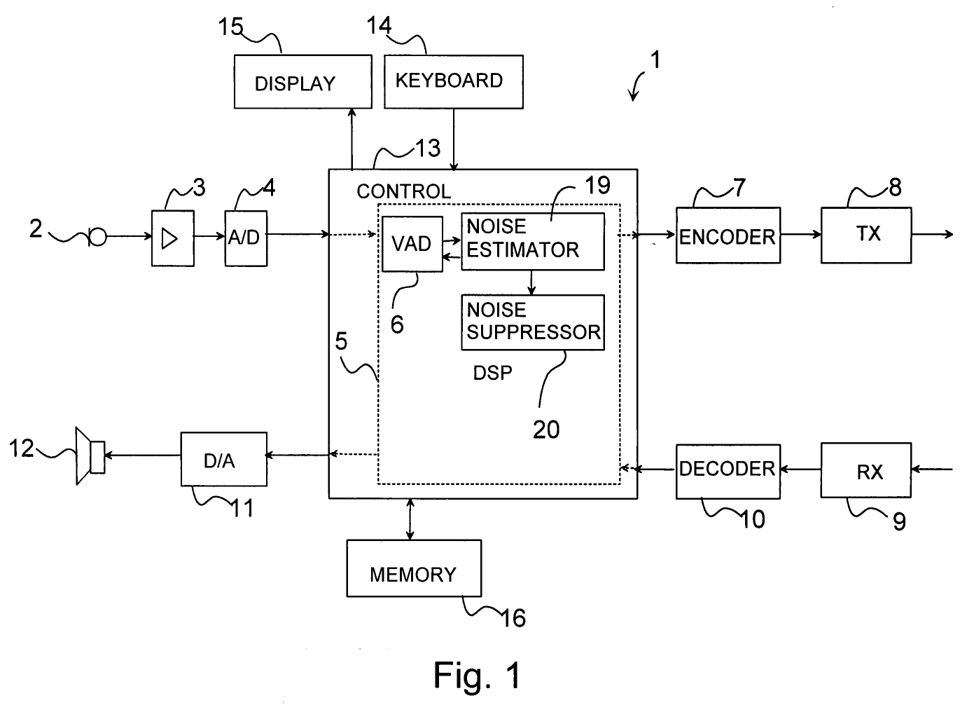

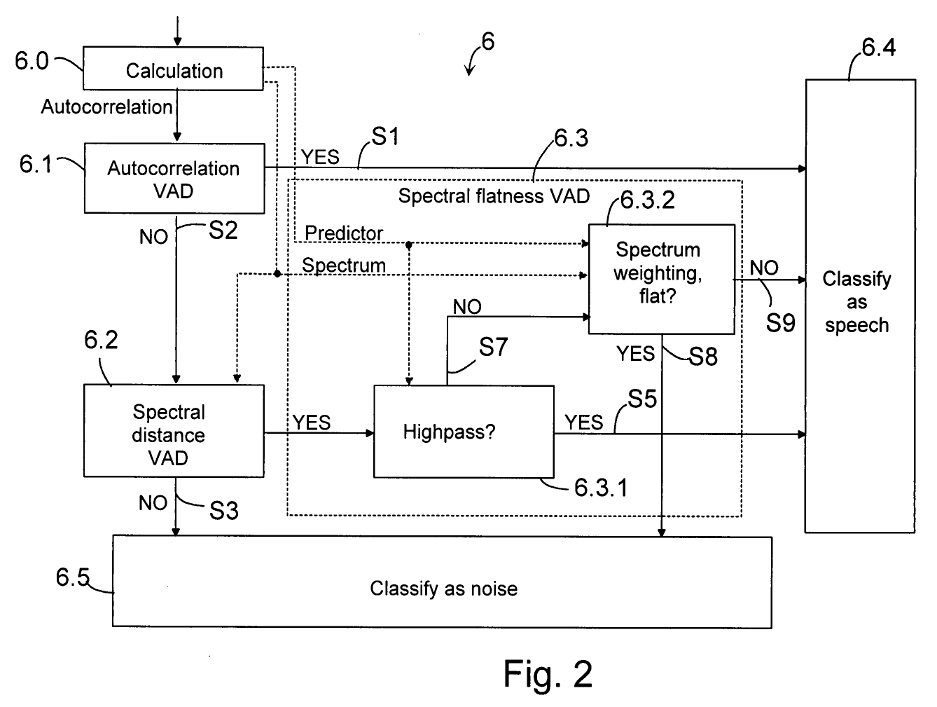

The invention will now be described in more detail with reference to the electronic device of FIG. 1 and the voice activity detector of FIG. 2. In this example embodiment the electronic device 1 is a wireless communication device but it is obvious that the invention is not restricted to wireless communication devices only. The electronic device 1 comprises an audio input 2 for inputting audio signal for processing. The audio input 2 is, for example, a microphone. The audio signal is amplified, when necessary, by the amplifier 3 and noise suppression may also be performed to produce an enhanced audio signal. The audio signal is divided into speech frames which means that a certain length of the audio signal is processed at one time. The length of the frame is usually a few milliseconds, for example 10 ms or 20 ms. The audio signal is also digitised in an analog/digital converter 4. The analog/digital converter 4 forms samples from the audio signal at certain intervals i.e. at a certain sampling rate. After the analog/digital conversion a speech frame is represented by a set of samples. The electronic device 1 has also a speech processor 5 in which the audio signal processing is at least partly performed. The speech processor 5 is, for example, a digital signal processor (DSP). The speech processor can also comprise other operations, such as echo control in the uplink (transmission) and/or downlink (reception).

The device 1 of FIG. 1 also comprises a control block 13 in which the speech processor 5 and other controlling operations can be implemented, a keyboard 14, a display 15, and memory 16.

The samples of the audio signal are input to the speech processor 5. In the speech processor 5 the samples are processed on a frame-by-frame basis. The processing may be performed in time domain or in frequency domain or in both. In noise suppression the signal is typically processed in frequency domain and each frequency band is weighted by a gain coefficient. The value of the gain coefficient depends on the level of noisy speech and the level of noise estimate. Voice activity detection is needed for updating the noise level estimate N(ω).

The voice activity detector 6 examines the speech samples to give an indication whether the samples of the current frame contain speech or non-speech signal. The indication from the voice activity detector 6 is input to a noise estimator 19 which can use this indication to estimate and update a spectrum of the noise when the voice activity detector 6 indicates that the signal does not contain speech. The noise suppressor 20 uses the spectrum of the noise to suppress noise in the signal. The noise estimator 19 may give feedback to the voice activity detector 6 on the background estimation parameter, for example. The device 1 may also comprise an encoder 7 to encode the speech for transmission.

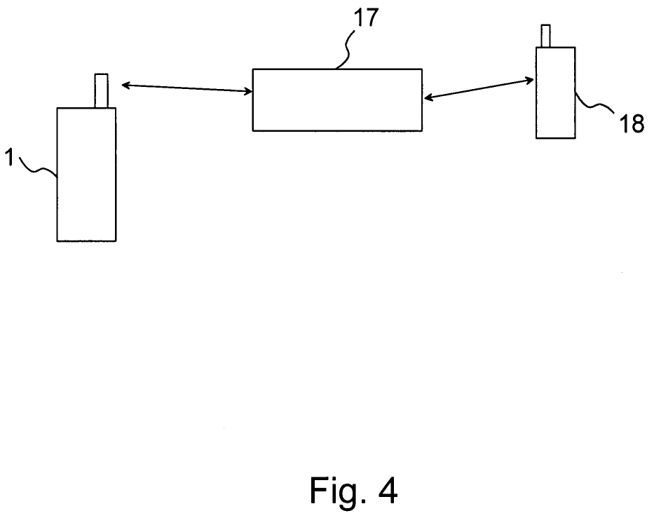

The encoded speech is channel coded and transmitted by a transmitter 8 via a communication channel 17, for example a mobile communication network, to another electronic device 18 such as a wireless communication device (FIG. 4).

In the receiving part of the electronic device 1 there is a receiver 9 for receiving signals from the communication channel 17. The receiver 9 performs channel decoding and directs the channel decoded signals to a decoder 10 which reconstructs the speech frames. The speech frames and noise are converted to analog signals by an digital to analog converter 11. The analog signals can be converted to audible signal by a loudspeaker or an earpiece 12.

It is assumed that the sampling frequency of 8000 Hz is used in the analog to digital converter wherein the useful frequency range is about from 0 to 4000 Hz which usually is enough for speech. It is also possible to use other sampling frequencies than 8000 Hz, for example 16000 Hz when also higher frequencies than 4000 Hz could exist in the signal to be converted into digital form.

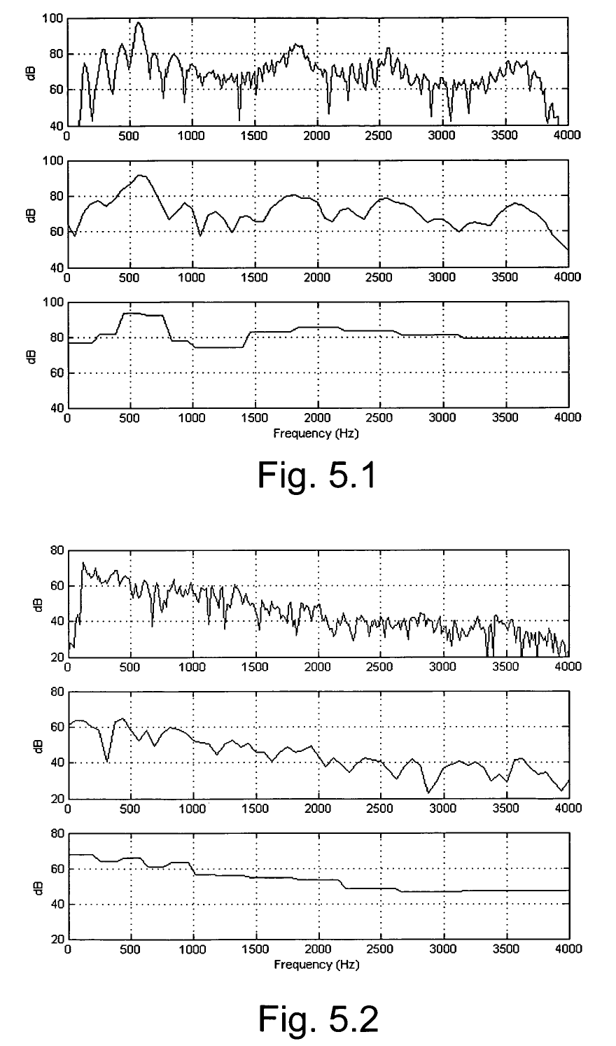

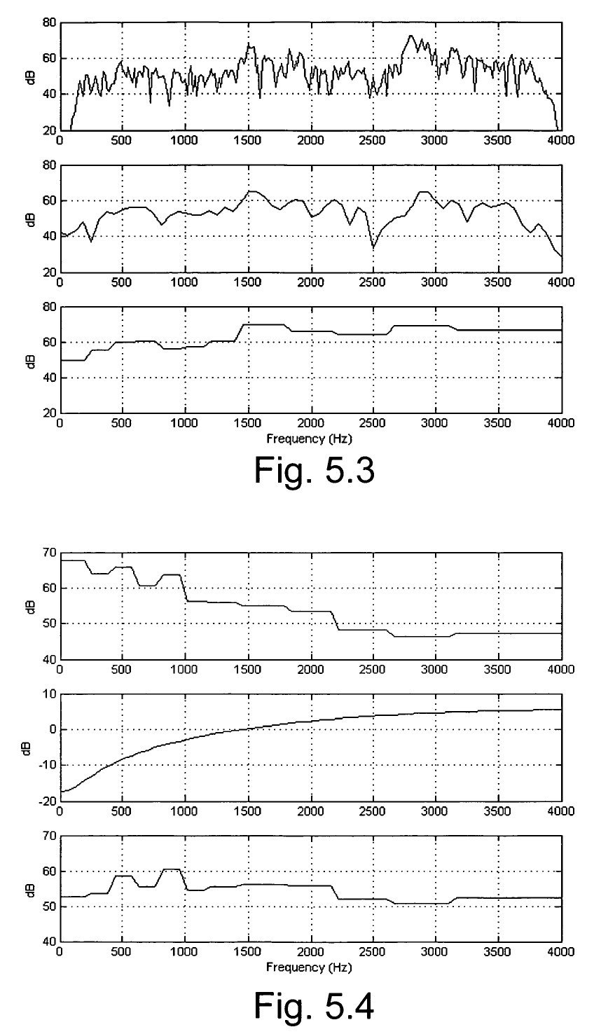

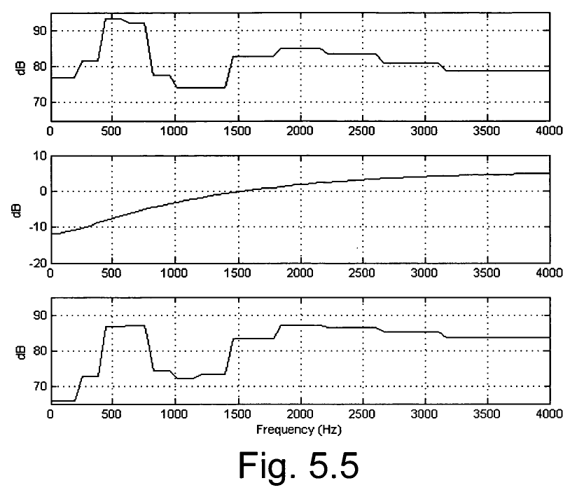

In the following, the theoretical background of the invention is described in more detail. First, the spectrum of a speech sample during one voiced phoneme (‘ee’, as in the word ‘men’) is considered. There are formant frequencies and valleys between them and in the case of voiced speech, also basis frequency, its harmonics and valleys between the harmonics. In a prior art noise suppressor disclosed in the international patent publication WO 01/37265 the frequency range from 0 to 4 kHz is divided into 12 calculation frequency bands (subbands) having unequal widths. Thus, the spectrum is smoothed quite heavily before computing the gain function used in suppression. However, as illustrated in FIG. 5.1 something of this irregularity remains. FIG. 5.1 illustrates examples of a spectrum of a voiced phoneme (‘ee’). The first curve is computed over a frame of 75 ms (FFT length 512), the second curve is computed over a frame of 10 ms (FFT length 128) and the third curve is computed over a frame of 10 ms and smoothed by frequency grouping.

In the case of noise, the spectrum is smoother as can be seen in FIG. 5.2 which illustrates examples of a spectrum of car noise. The first curve is computed over a frame of 75 ms (FFT length 512), the second curve is computed over a frame of 10 ms (FFT length 128) and the third curve is computed over a frame of 10 ms (smoothed by frequency grouping). As illustrated in FIG. 5.2, after all smoothing the spectrum resembles a straight line going downwards. In the case of unvoiced consonants, the spectrum is also rather smooth but goes upwards, as is illustrated in FIG. 5.3. FIG. 5.3 illustrates examples of a spectrum of an unvoiced consonant (the phoneme ‘t’ in the word control). The first curve is computed over a frame of 75 ms (FFT length 512), the second curve is computed over a frame of 10 ms (FFT length 128) and the third curve is computed over a frame of 10 ms (smoothed by frequency grouping).

In the following the operation of an example embodiment of the spectral flatness VAD 6.3 according to the present invention will be described. First, the optimal first order predictor A(z)=1−az⁻¹ corresponding to the current and the previous frame is computed in time domain. The predictor coefficient a is computed by

$$a = \frac{\sum x ( t ) x ( t - 1 )}{\sum {x ( t )}^{2}}$$

over the current frame. The spectral flatness VAD examines in block 6.3.1 if a≦0 which means that the spectrum has a highpass nature and it can be the spectrum of an unvoiced consonant. Then the frame is classified as speech and the spectral flatness VAD 6.3 outputs the indication of speech (for example a logical 1).

If a>0 then the current noisy speech spectrum estimate is weighted in block 6.3.2 and the weighting is carried out in frequency domain after frequency grouping using the values of the cosine function corresponding to the middles of the bands. The weighting function results as
|A(e^{jω}^{ₘ})|²=1+a²−2a cos ωₘ
where ωₘ refers to the middle frequency of the frequency band. Comparison of the smallest Xₘᵢₙ and largest Xₘₐₓ values of the weighted spectrum |A(e_{jω}^{ₘ})|²X(ω,n) does the VAD decision. The values corresponding to frequencies below 300 Hz and above 3400 Hz are omitted in this example embodiment. If Xₘₐₓ≧2^{thr} Xₘᵢₙ the signal is classified as speech, the ratio corresponding to approximately thr×3 dB.

The effect of the weighting of noise and voiced speech spectrum is shown in FIG. 5.4 and FIG. 5.5, respectively. As we see, in this case 12 dB is a sufficient threshold for distinguishing between noise and speech.

Spectral flatness VAD can be used alone, but it is also possible to use it in connection with a spectral distance VAD that operates in frequency domain. The spectral distance VAD classifies as speech if the sum a posteriori signal-to-noise ratio (SNR) exceeds a predefined threshold and in the case of suddenly rising background noise power it begins to classify all frames as noise; more detailed description can be found in the publication WO 01/37265. Thus, in this embodiment the threshold in spectral flatness VAD could even be smaller than 12 dB, since only a few correct decisions are needed in order to update the level of the noise estimate so that spectral distance VAD classifies correctly. There is still a small risk that noise-like phonemes in speech are incorrectly classified as noise. However, the occasional incorrect decisions do not usually have any audible effect in speech quality in noise suppression provided that the smoothing parameter (λ) in noise estimation is sufficiently high.

The spectral distance VAD and spectral flatness VAD can also be used in connection with autocorrelation VAD. An example of this kind of implementation is shown in FIG. 2. Autocorrelation VAD is computationally demanding but robust method for detecting voiced speech and it detects speech also in low signal-to-noise ratio where the other two VADs classify as noise. Moreover, sometimes voiced phonemes have clear periodicity, but rather flat spectrum. Thus, for high quality noise suppression the combination of all three VAD decisions may be needed although the computational complexity of autocorrelation VAD can be too high for some applications.

The decision logic of the combination of voice activity detectors can be expressed in a form of a truth table. Table 1 shows the truth table for the combination of autocorrelation VAD 6.1, spectral distance VAD 6.2 and spectral flatness VAD 6.3. The columns indicate the decisions of the different VADs in different situations. The rightmost column means the result of the decision logic i.e. the output of the voice activity detector 6. In the table the logical value 0 means that the output of the corresponding VAD indicates noise and the logical value 1 means that the output of the corresponding VAD indicates speech. The order in which the decisions are made in different VADs 6.1, 6.2, 6.3 is made does not have any effect on the result as long as the decision logic operates according to the truth table of Table 1.

TABLE 1

| Autocorrelation | Spectral | Spectral flatness | |
|---|---|---|---|
| VAD | distance VAD | VAD | Decision |
| 0 | 0 | 0 | 0 |
| 0 | 0 | 1 | 0 |
| 0 | 1 | 0 | 0 |
| 0 | 1 | 1 | 1 |
| 1 | 0 | 0 | 1 |
| 1 | 0 | 1 | 1 |
| 1 | 1 | 0 | 1 |
| 1 | 1 | 1 | 1 |

Further, the internal decision logic of the spectral flatness VAD 6.3 can be expressed as the truth table of Table 2. The columns indicate the decisions of the highpass detection block 6.3.1, the spectrum analysis block 6.3.2 and the output of the spectral flatness VAD. In the table the logical value 0 in the highpass nature column means that the spectrum does not have highpass nature and the logical value 1 means spectrum of high pass nature. The logical value 0 in the flat spectrum column means that the spectrum is not flat and the logical value 1 means that the spectrum is flat.

TABLE 2

| Highpass nature | Flat spectrum | Decision |
|---|---|---|
| 0 | 0 | 1 |
| 0 | 1 | 0 |
| 1 | 0 | 1 |
| 1 | 1 | 1 |

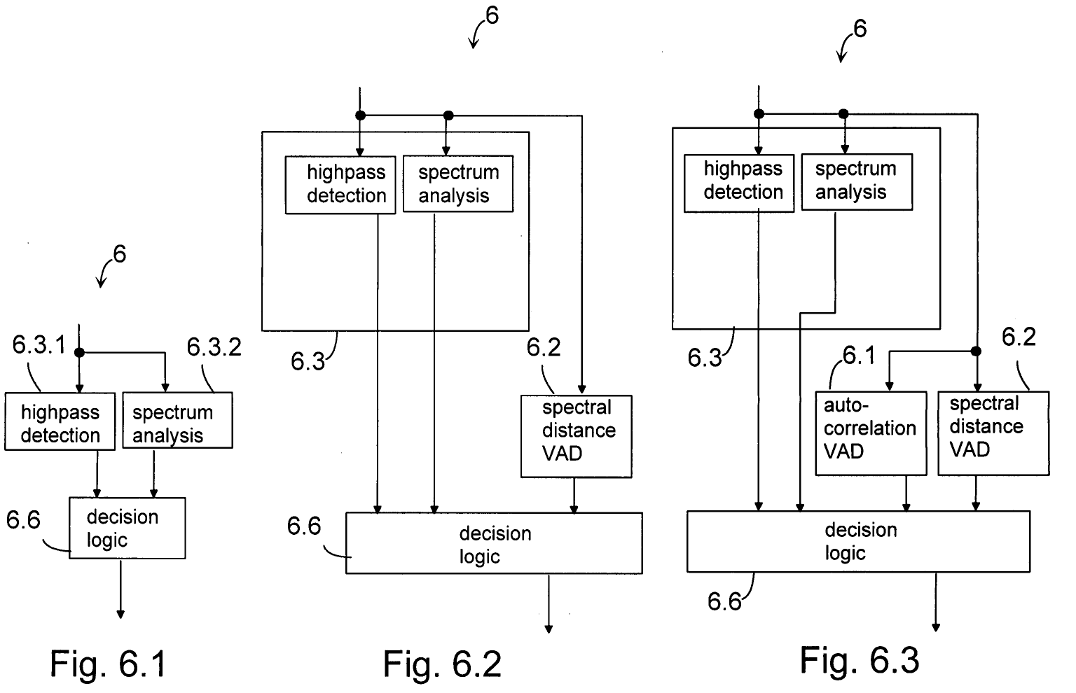

In the simplified block diagram of FIG. 6.1 the voice activity detector 6 is implemented using the spectral flatness VAD 6.3 only, in FIG. 6.2 the voice activity detector 6 is implemented using the spectral flatness VAD 6.3 and the spectral distance VAD 6.2, and in FIG. 6.3 the voice activity detector 6 is implemented using the spectral flatness VAD 6.3, the spectral distance VAD 6.2, and the autocorrelation VAD 6.1. The decision logic is depicted with the block 6.6. In these non-restricting example embodiments the different VADs are shown as parallel.

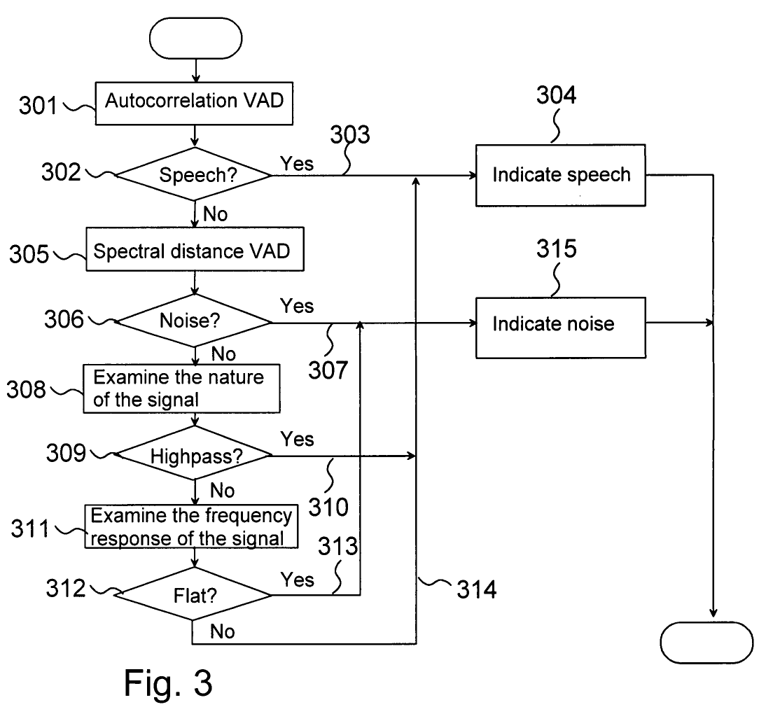

In the following the voice activity detection according to an example embodiment of the present invention using both autocorrelation VAD and spectral distance VAD in connection with the spectral flatness VAD is described in more detail with reference to the flow diagram of FIG. 3.

The voice activity detector 6 calculates autocorrelation coefficients
r(0)=Σx²(t)
and
r(τ)=Σx(t)×(t−τ), τ=16, . . . ,81
for the autocorrelation VAD 6.1, and the optimal first order predictor A(z)=1−az⁻¹, where

$$a = \frac{\sum x ( t ) x ( t - 1 )}{\sum {x ( t )}^{2}} ,$$

for the spectral flatness VAD 6.2 on the basis on the time domain signal. Then the FFT is calculated to obtain the frequency domain signal for the spectral flatness VAD 6.2 and for the spectral distance VAD 6.3. The frequency domain signal is used to evaluate the power spectrum X(ω,n) of the noisy speech frame corresponding to frequency bands ω. The calculation of the autocorrelation coefficients, first order predictor and FFT is illustrated as the calculation block 6.0 in FIG. 2 but it is obvious that the calculation can also be implemented in other parts of the voice activity detector 6, for example in connection with the autocorrelation VAD 6.1. In the voice activity detector 6 the autocorrelation VAD 6.1 examines whether there is periodicity in the frame using the autocorrelation coefficients (block 301 in FIG. 3).

All the autocorrelation coefficients are normalized with respect to the 0-delay coefficient r(0) and the maximum of the autocorrelation coefficients is calculated max{r(16), . . . ,r(81)} in the samples range corresponding to frequencies in the range [100, 500] Hz. If this value is bigger than a certain threshold (block 302), then the frame is considered to contain speech (arrow 303), if not, the decision relies on the spectral distance VAD 6.2 and the spectral flatness VAD 6.3.

The autocorrelation VAD produces a speech detection signal S1 to be used as an output of the voice activity detector 6 (block 6.4 in FIG. 2 and block 304 in FIG. 3). If, however, the autocorrelation VAD did not find enough periodicity in the samples of the frame, the autocorrelation VAD does not produce a speech detection signal S1 but it can produce a non-speech detection signal S2 indicative of signal having no periodicity or only a minor periodicity. Then, the spectral distance voice activity detection is performed (block 305). The sum a posteriori SNR

$$\sum \frac{X ( ω , n )}{N ( ω , n - 1 )}$$

is computed and compared to a predefined threshold (block 306). If the spectral distance VAD 6.2 classifies the frame as noise (arrow 307) this indication S3 is used as the output of the voice activity detector 6 (block 6.5 in FIG. 2 and block 315 in FIG. 3). Otherwise, the spectral flatness VAD 6.3 makes further actions for deciding whether there is noise or active speech in the frame.

The spectral flatness VAD 6.3 receives the optimal first order predictor A(z)=1−az⁻¹ and the spectrum X(ω,n) because further analysis of the signal is needed (block 308). First, the highpass detecting block 6.3.1 of the spectral flatness VAD 6.3 examines whether the value of the predictor coefficient is less or equal than zero a≦0 (block 309). If so, the frame is classified as speech since this parameter indicates that the spectrum of the signal has a highpass nature. In that case the spectral flatness VAD 6.3 provides an indication S5 of speech (arrow 310). If the highpass detection block 6.3.1 determines that the condition a≦0 is not true for the current frame it gives an indication S7 to the spectrum analysis block 6.3.2 of the spectral flatness VAD 6.3. The spectrum analysis block 6.3.2 weights the frequency bands ω with |A(e^{jω}^{ₘ})|²=1+a²−2a cos ωₘ (block 311). The frequency ωₘ is normalized to (0,π) with a value corresponding to the middle frequency of frequency band ω. The maximum and minimum values on the weighted frequencies |A(e^{jω}^{ₘ})|²X(ω) are then compared (block 312). If the ratio between the maximum value and the minimum value on the weighted frequencies is below a threshold (e.g. 12 dB) the frame is classified as noise (arrow 313) and the indication S8 is formed. Otherwise, the frame is classified as speech (arrow 314) and the indication S9 is formed (block 304). If the spectral flatness VAD 6.3 determines that the frame contains speech (indications S5 and S9 above), the voice activity detector 6 produces an indication of (noisy) speech (block 304). Otherwise (indication S8 above), the voice activity detector 6 produces an indication of noise (block 315).

The invention can be implemented e.g. as a computer program in a digital signal processing unit (DSP) in which the machine executable steps to perform the voice activity detection can be provided.

The voice activity detector 6 according to the invention can be used in the noise suppressor 20, e.g. in the transmitting device as was shown above, in a receiving device, or both. The voice activity detector 6 and also other signal processing elements of the speech processor 5 can be common or partly common to the transmitting and receiving functions of the device 1. It is also possible to implement voice activity detector 6 according to the present invention in other parts of the system, for example in some element(s) of the communication channel 17. Typical applications for noise suppression are related with speech processing where the intention is to make the speech more pleasant and understandable to the listener or to improve speech coding. Since speech codecs are optimized for speech, the deterious effect of noise can be great. It is also possible to use the voice activity detector 6 according to the invention in connection with other purposes than noise suppression, for example in discontinuous transmission to indicate when speech or noise should be transmitted.

The spectral flatness VAD according to the present invention can be used alone for voice activity detection and/or noise estimation but it is also possible to use the spectral flatness VAD in connection with a spectral distance VAD, for example with the spectral distance VAD as described in the publication WO 01/37265, in order to improve noise estimation in the case of suddenly raising noise power. Moreover, the spectral distance VAD and the spectral flatness VAD can also be used in connection with autocorrelation VAD in order to achieve good performance in low SNR.

It is obvious that the present invention is not limited solely to the above described embodiments but it can be modified within the scope of the appended claims.

What is claimed is:

1. A device comprising a voice activity detector for detecting voice activity in a speech signal using digital data formed on the basis of samples of an audio signal, the voice activity detector of the device comprising:
a first element adapted to examine, whether the signal has a highpass nature; and
a second element adapted to examine the frequency spectrum of the signal;
wherein the voice activity detector is adapted to provide an indication of speech when one of the following conditions is fulfilled:
the first element has determined that the signal has a highpass nature; or
the second element has determined that the signal does not have a flat frequency response.

2. The device according to claim 1, wherein the voice activity detector is further adapted to provide an indication of noise when the first element has determined that the signal has not highpass nature and the second element has determined that the signal has flat frequency response.

3. The device according to claim 1, the voice activity detector also comprising a spectral distance voice activity detector for examining frequency properties of the signal and for producing spectral distance detection data on the basis of the examination, the spectral distance detection data providing an indication of speech or an indication of noise.

4. The device according to claim 1, the voice activity detector also comprising an autocorrelation voice activity detector for examining autocorrelation properties of the signal and for producing autocorrelation detection data on the basis of the examination, wherein the spectral distance voice activity detector is adapted to produce the spectral distance detection data when the autocorrelation detection data does not indicate speech.

5. The device according to claim 4, the voice activity detector comprising a decision block to form a decision signal on the basis of the combination of indications of the different voice activity detectors.

6. The device according to claim 1, wherein the voice activity detector (6) is adapted to calculate a first order predictor A(z)=1−az⁻¹ corresponding to a current and a previous frame of the digital data, in which the predictor coefficient a is computed by
$$a = \frac{\sum x ( t ) x ( t - 1 )}{\sum {x ( t )}^{2}} .$$

7. The device according to claim 6, the voice activity detector comprising a first element to examine if the value of the predictor coefficient a is less or equal to a predetermined value to use the result of the examination in providing the indication of speech.

8. The device according to claim 7, the voice activity detector comprising a second element to calculate a weighted spectrum estimate and to compare the smallest and largest values of the weighted spectrum to a second predetermined value to use the result of the comparison in providing the indication of noise or speech.

9. A voice activity detector for detecting voice activity in a speech signal containing noise using digital data formed on the basis of samples of an audio signal, the voice activity detector comprising:
a first element adapted to examine, whether the signal has a highpass nature; and
a second element adapted to examine the frequency spectrum of the signal;
wherein the voice activity detector is adapted to provide an indication of speech when one of the following conditions is fulfilled:
the first element has determined that the signal has a highpass nature; or
the second element has determined that the signal does not have a flat frequency response.

10. The voice activity detector according to claim 9, wherein the voice activity detector is further adapted to provide an indication of noise when the first element has determined that the signal has not highpass nature and the second element has determined that the signal has flat frequency response.

11. The voice activity detector according to claim 9 also comprising a spectral distance voice activity detector (6.2) for examining frequency properties of the signal and for producing spectral distance detection data on the basis of the examination, the spectral distance detection data providing an indication of speech or an indication of noise.

12. The voice activity detector according to claim 9 also comprising an autocorrelation voice activity detector for examining autocorrelation properties of the signal and for producing autocorrelation detection data on the basis of the examination, wherein the spectral distance voice activity detector is adapted to produce the spectral distance detection data when the autocorrelation detection data does not indicate speech.

13. The voice activity detector according to claim 12 comprising a decision block to form a decision signal on the basis of the combination of indications of the different voice activity detectors.

14. The voice activity detector according to claim 12, wherein the spectral distance detection data comprises autocorrelation parameters, wherein the first element is adapted to examine the autocorrelation parameters to determine the highpass nature of the signal.

15. The voice activity detector according to claim 9, wherein the voice activity detector is adapted to calculate a first order predictor A(z)=1−az⁻¹ corresponding to a current and a previous frame of the digital data, in which the predictor coefficient a is computed by
$$a = \frac{\sum x ( t ) x ( t - 1 )}{\sum {x ( t )}^{2}} .$$

16. The voice activity detector according to claim 15 comprising a first element to examine if the value of the predictor coefficient a is less or equal to a predetermined value to use the result of the examination in providing the indication of speech.

17. The voice activity detector according to claim 16 comprising a second element to calculate a weighted spectrum estimate and to compare the smallest and largest values of the weighted spectrum to a second predetermined value to use the result of the comparison in providing the indication of noise or speech.

18. A system comprising a voice activity detector for detecting voice activity in a speech signal containing noise using digital data formed on the basis of samples of an audio signal, the voice activity detector of the system comprising:
a first element adapted to examine, whether the signal has a highpass nature; and
a second element adapted to examine the frequency spectrum of the signal;
wherein the voice activity detector is adapted to provide an indication of speech when one of the following conditions is fulfilled:
the first element has determined that the signal has a highpass nature; or
the second element has determined that the signal does not have a flat frequency response.

19. The device according to claim 18, wherein the voice activity detector is further adapted to provide an indication of noise when the first element has determined that the signal has not highpass nature and the second element has determined that the signal has flat frequency response.

20. A method for detecting voice activity detector in a speech signal containing noise using digital data formed on the basis of samples of an audio signal comprising:
examining, whether the signal has a highpass nature;
examining the frequency spectrum of the signal; and
providing an indication of speech when one of the following conditions is fulfilled:
it is determined that the signal has a highpass nature; or
it is determined that the signal does not have a flat frequency response.

21. The method according to claim 20 comprising providing an indication of noise when it is determined that the signal has not highpass nature and that the signal has flat frequency response.

22. The method according to claim 20 also comprising examining frequency properties of the signal and producing spectral distance detection data on the basis of the examination, the spectral distance detection data providing an indication of speech or an indication of noise.

23. The method according to claim 20 also comprising examining autocorrelation properties of the signal and producing autocorrelation detection data on the basis of the examination, wherein the method comprises producing the spectral distance detection data when the autocorrelation detection data does not indicate speech.

24. The method according to claim 23 also comprising forming a decision signal on the basis of the combination of indications of the different voice activity detections.

25. The method according to claim 23, wherein the spectral distance detection data comprises autocorrelation parameters, wherein the method comprises examining the autocorrelation parameters to determine the highpass nature of the signal.

26. The method according to claim 20 comprising calculating a first order predictor A(z)=1−az⁻¹ corresponding to a current and a previous frame of the digital data, in which the predictor coefficient a is computed by
$$a = \frac{\sum x ( t ) x ( t - 1 )}{\sum {x ( t )}^{2}} .$$

27. The method according to claim 26 also comprising examining if the value of the predictor coefficient a is less or equal to a predetermined value and using the result of the examination in providing the indication of speech.

28. The method according to claim 27 also comprising calculating a weighted spectrum estimate and comparing the smallest and largest values of the weighted spectrum to a second predetermined value and using the result of the comparison in providing the indication of noise or speech.

29. A computer program product comprising machine executable steps for
detecting voice activity detector in a speech signal containing noise using digital data formed on the basis of samples of an audio signal, examining, whether the signal has a highpass nature;
examining the frequency spectrum of the signal; and
providing an indication of speech when one of the following conditions is fulfilled:
the signal has a highpass nature; or
the signal does not have a flat frequency response.

30. The computer program product according to claim 29 comprising machine executable steps for providing an indication of noise when the signal has not highpass nature and that the signal has flat frequency response.
